(19) United States
(12) Patent Application Publication
(10) Pub. No.: US 2005/0092581 A1
(43) Pub. Date: May 5, 2005

(54) Automatically aligning stacks of planar food product

(75) Inventor: Eugene W. Walker, Yakima, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: ARR Tech, Inc.

(21) Appl. No.: 10/701,901

(22) Filed: Nov. 4, 2003

(51) Int. Cl. B65G 47/26

(52) U.S. Cl. 198/433; 198/468.8

(57) ABSTRACT

A conveyor transfer apparatus (100) is disclosed for transferring stacks of product, such as tortillas, from multiple rows on a multiple-row conveyor (90) in a single row onto a single-row conveyor (150). The single-row conveyor is disposed adjacent to, and oriented transversely to the multiple-row conveyor. A plurality of retractable fork members (110) extends from a backstop (130) to the first conveyor to receive a stack. When a stack is delivered to a retractable fork member and is ready for transfer, an elevator member (160) extends upwardly from the single-row conveyor towards a fork member. The fork member retracts, depositing the stack on the elevator member. The elevator member then retracts to the second conveyor, depositing the stack thereon. In a disclosed embodiment, the elevator member includes a plurality of parallel, spaced, vertical panels (162) that extends between adjacent conveyor belts (152) on the single-row conveyor.

### FIELD OF THE INVENTION

The present invention relates to food processing equipment and, in particular, to systems for moving stacked food product in a production environment.

### BACKGROUND OF THE INVENTION

Tortilla production and sales is a large industry, by industry estimates accounting for over five billion dollars in sales in 2002. The production of flat food products such as tortillas, like much of the commercial food industry, conventionally requires significant manual labor that is repetitive and boring, and may lead to injuries such as repetitive motion injuries or injuries related to worker inattention around moving and/or hot equipment. Moreover, the use of manual labor for repetitive tasks underutilized resources and is economically inefficient. For these reasons, the food production industry has turned increasingly to technology to eliminate or reduce tasks that are amenable to automation, freeing the human resources for more appropriate tasks.

The production of flat food products presents special challenges. For example, tortillas are generally cooked in a continuous process, wherein the tortillas are transported on a moving conveyor through a conveyor oven, the tortillas being arranged in a number of rows as they pass through the oven. Typically, the tortillas are subsequently accumulated into stacks-for example, 10 to 20 tortillas high (or more)—so that the tortillas can be inserted into bags. Examples of a counting, inspecting, and/or stacking apparatus are disclosed in U.S. Pat. No. 4,530,632, issued to Sela, and U.S. Pat. No. 5,720,593, issued to Pleake, both of which are hereby incorporated by reference. In the apparatus disclosed by Pleake, the tortillas are fed from a conveyor into a trajectory guide and flung through a known flight trajectory to a stacking mechanism. A shaker jostles the stack of tortillas on a movable stack plate, which is lowered to deposit the stack onto a baseplate, wherein a stack removal device moves the stack of tortillas away from the stacking assembly. The stacks of tortillas, disposed in multiple rows or lanes, are transported to a pickup area where they may be manually bagged or moved into a single row on a conveyor for delivery to packaging. Bagging systems are known that will automatically process a single row of stacks of tortillas on a conveyor, automatically inserting the stacks into bags.

The latter manual step is repetitive and inefficient. However, heretofore it has been necessary to accomplish this task by hand for several reasons. First, the stacks of tortillas exit the stacking apparatus in multiple rows or lanes, and in a substantially random order. The irregular ordering is due to irregular placement of the tortillas prior to cooking, inspection, and removal of defective products, and similar factors. Also, typically, the size of the stacks, as well as the diameter of the tortillas, may be adjustable for a given apparatus. It is more difficult to move stacked product in an automated manner due to the tendency of the stacks to tip over (or slidably spread out) due to inertial forces and the like.

Recognizing the need for an apparatus for automatically transferring stacks of tortillas from a multi-row stacker to a single-row conveyor, U.S. Pat. No. 6,454,518, to Garcia-Balleza et al., discloses an apparatus wherein stacks of tortillas are dropped from an upper conveyor onto conveyor blocks disposed on an lower conveyor. Although the disclosed device is an improvement on the art, a disadvantage of the invention taught therein is that the stacks of tortillas may become unstacked due to the abrupt drop onto a moving block. Another disadvantage is that the disclosed system does not appear to be amenable to use with more than one size of tortilla. Garcia-Balleza et al. shows many conventional aspects of suitable conveyor systems, and is therefore also incorporated herein by reference.

Therefore, there remains a need for an apparatus that automatically transfers stacked food product arriving in multiple rows onto a conveyor in a single row.

### SUMMARY OF THE INVENTION

A conveyor transfer apparatus and method are disclosed for transferring stacks of flat product, such as stacks of tortillas, arriving in multiple rows—for example, from a stacking apparatus—onto a second conveyor such that the stacks are oriented in a single row and ready for further processing. The second conveyor is disposed below and adjacent to a distal end of the first conveyor, and is oriented transversely thereto. The transfer apparatus includes a plurality of horizontally movable fork members that extends between a backstop disposed opposite the first conveyor and the distal end of the first conveyor, such that it will receive stacks from the first conveyor. When a stack is in position on a fork member for transfer, an elevator extends upwardly from the second conveyor towards the fork member. The fork member then retracts, pulling the stack towards the backstop, thereby slidably disengaging from the stack, and depositing it on the elevator. The elevator then retracts, gently depositing the stack on the second conveyor.

In an aspect of the invention, the elevator includes a plurality of parallel, vertical panels that are sized and spaced to extend between adjacent conveyor belts on the second conveyor, such that when the elevator retracts, the upper end of the elevator is disposed below the top surface of the conveyor, whereby the conveyor receives the stack from the elevator.

In an embodiment of the invention, a plurality of detectors is provided for detecting when a stack is in a predetermined position. A controller receives signals from the detectors and controls the operation of the fork members and the elevators, such that the elevators and fork members extend and retract in a manner that prevents unwanted interference by the stacks and the elevators, while depositing the stacks onto the second conveyor.

In a method of transferring stacks of flat product according to the present invention, the second conveyor is positioned below the first conveyor, near its terminal end; horizontal fork members are each positioned to receive a stack of flat product from a first conveyor. While a fork member has a stack in position for transfer, an elevator extends from the second conveyor and the forked member is retracted, depositing the stack on the elevator. The elevator then retracts to position the stack on the second conveyor.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a conveyor transfer apparatus according to the present invention, wherein some conventional support structure is removed for clarity;

FIG. 2 shows a front view of the conveyor transfer apparatus shown in FIG. 1, with the multi-row conveyor removed for clarity;

FIGS. 3A-3D are side views of the conveyor transfer apparatus shown in FIG. 1, showing a sequence of steps to move a stack from the multi-lane conveyor to the single-lane conveyor;

FIG. 4 shows a flow chart illustrating the operation of the conveyor transfer apparatus of FIG. 1; and

FIG. 5 shows a perspective view of the conveyor transfer apparatus shown in FIG. 1, set up to work with larger stacked product, wherein the transfer components are operated in tandem.

### DETAILED DESCRIPTION OF THE PREFERRED EMBODIMENT

Referring now to the figures, wherein like numbers indicate like parts, a description of a preferred embodiment of the present invention is described to help the artisan understand the invention.

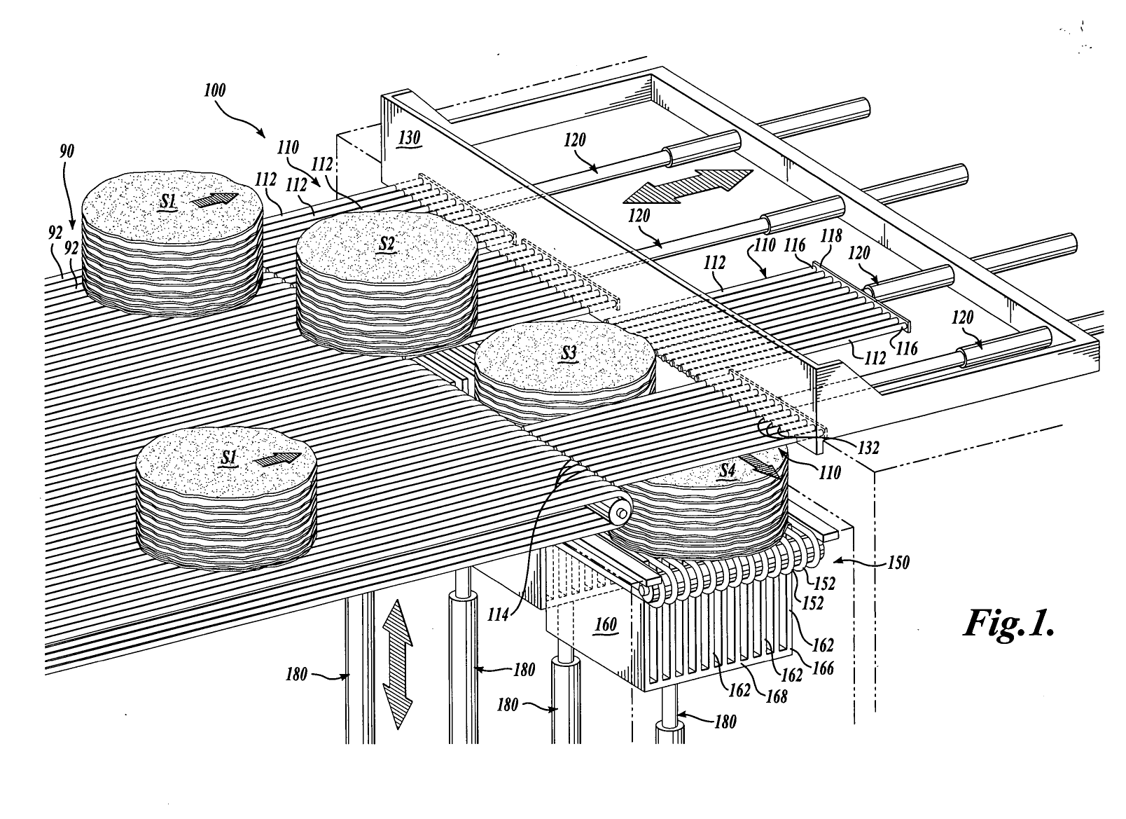

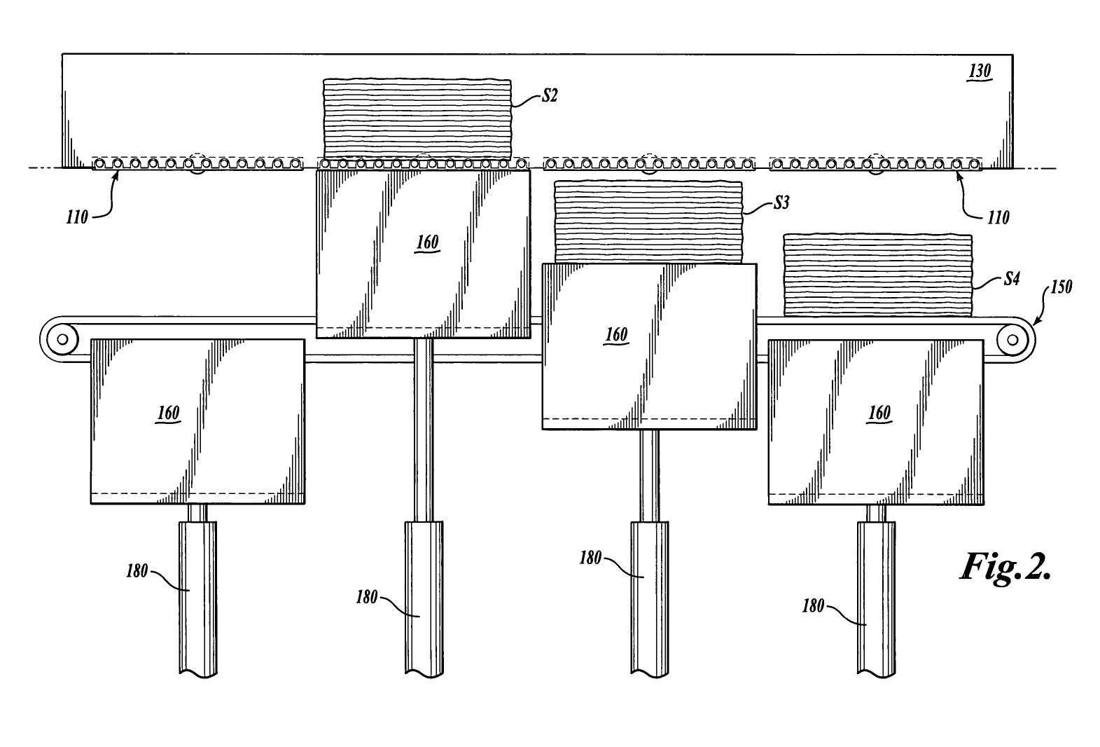

FIG. 1 shows a perspective view of a simplified conveyor transfer apparatus 100 according to the present invention, wherein conventional and well-known structures, such as support structure and drive mechanisms, are removed in order to better show the novel aspects of the present invention, and FIG. 2 shows a front view of the conveyor transfer apparatus 100. A portion of a conventional multi-row conveyor 90 is shown transporting several stacks S1, S2, S3, S4 of flat product, such as tortillas, from a previous processing apparatus such as a stacker (not shown) to the transfer apparatus 100. In the disclosed embodiment the multi-row conveyor 90 includes a plurality of parallel, spaced-apart, endless-loop conveyor belts 92.

The stacks S1, S2, S3, S4 are shown generally in four rows or lanes, although more or fewer rows may alternatively be used. The transfer apparatus 100 is located at the distal end of the multi-row conveyor 90 and positioned to receive the stacks S1, S2, S3, S4. The transfer apparatus 100 receives the stacks from the multi-row conveyor 90 and gently places them on a single-row conveyor 150, located at a height below the multi-row conveyor 90, and oriented transversely to the multi-row conveyor 90, where the stacks may be transported for further processing, for example to an automated bagging apparatus.

In FIG. 1 the stacks S1 are being moved by the multi-row conveyor 90 toward the transfer apparatus 100, as indicated by the arrows. The stack S2 is in position to be moved to the single-row conveyor 150; the stack S3 is in the process of being moved to the single-row conveyor 150; and stack S4 is in transit, being conveyed by the single-row conveyor 150. The single-row conveyor 150 may extend further than shown in the FIGURES, or another conveyor or other apparatus (not shown) may be positioned to receive the stacks from the single-row conveyor 150.

The transfer apparatus 100 includes a plurality of horizontal, retractable fork members 110 (four shown). Each retractable fork member 110 has a number of spaced, parallel fingers 112. The fingers 112 are attached at a proximal end 116 to a transverse member 118, and have a free distal end 114. The free distal end 114 of the fingers 112 are preferably sized and spaced such that the distal ends 114 may be disposed generally between adjacent conveyor belts 92 when the fork member 110 is extended. The fingers 112 may be positioned slightly lower than the top of the conveyor belts 92, to facilitate the multi-row conveyor 90 moving the stacks onto the fork members 110.

The transverse member 118 of each fork 110 is mechanically attached to an actuator 120, as is well known in the art. The actuator 120 may be of any suitable design, including, for example, hydraulic, pneumatic, electromagnetic, or gear-driven. The actuators 120 are controlled to selectively move the fork member 110 from an extended position wherein the distal ends 114 are generally adjacent the multi-lane conveyor 90 and a retracted position wherein the distal ends 114 are disposed away from the multi-lane conveyor 90.

A backstop 130, which is preferably a substantially flat and upright wall, is disposed opposite the multi-row conveyor 90. A lower edge of the backstop 130 has a plurality of apertures or recesses 132, that are shaped to slidably accommodate the fingers 112 of the fork members 110. In the disclosed embodiment, the recesses 132 are positioned, such that a short portion of the backstop 130 extends downwardly, at least partially between adjacent fingers 112 of the fork members 110. When the fork member 110 is moved to the retracted position, the free distal ends 114 of the fingers 112 are disposed at or behind the backstop 130.

It may now be appreciated from FIGS. 1 and 2 that, when a stack such as stack S2 is in position to be moved to the single-row conveyor 150, the corresponding fork 110 may be selectively retracted, pulling the stack S2 towards the backstop 130. The backstop 130 blocks the stack at a desired horizontal position over the single-row conveyor 150, as the fork 110 is retracted through the backstop 130, and allows the fingers 112 to slidably disengage from the stack, as shown for stack S3. In the preferred embodiment, the backstop 130 is adjustable in the horizontal direction, whereby the horizontal stop position for the stacks may be set to a desired position.

The single-row conveyor 150 is disposed below the multi-row conveyor 90, and generally between the multi-row conveyor 150 and the backstop 130. In the preferred embodiment, the single-row conveyor 150, similar to the multi-row conveyor 90, comprises a number of parallel, spaced-apart, endless-loop conveyor belts 152. This type of conveyor is well known in the art. The single-row conveyor 150 is oriented to move the stacks generally perpendicular to their direction of travel on the multi-row conveyor 90.

A plurality of retractable vertical elevators 160 (four shown) is disposed below the single-row conveyor 150. The elevators 160 include a number of vertical, parallel panels 162, each panel having a free distal end 164 and a proximal end 166 that are connected to a transverse member 168. The parallel panels 162 are sized and spaced to pass between adjacent endless loop belts 152 of the single-row conveyor 150. It will be appreciated that the vertical panels 162 and the transverse member 168 may be formed as a unitary component, or assembled as a composite structure.

The elevators 160 are attached to vertical actuators 180, and are thereby selectively positionable between an extended position, wherein the distal end 164 of the panels 162 is disposed near the fingers 112 of corresponding forks 110, and a retracted position wherein the distal end 164 of the panels is disposed below the top of the endless loop belts 152 of the single-row conveyor 150.

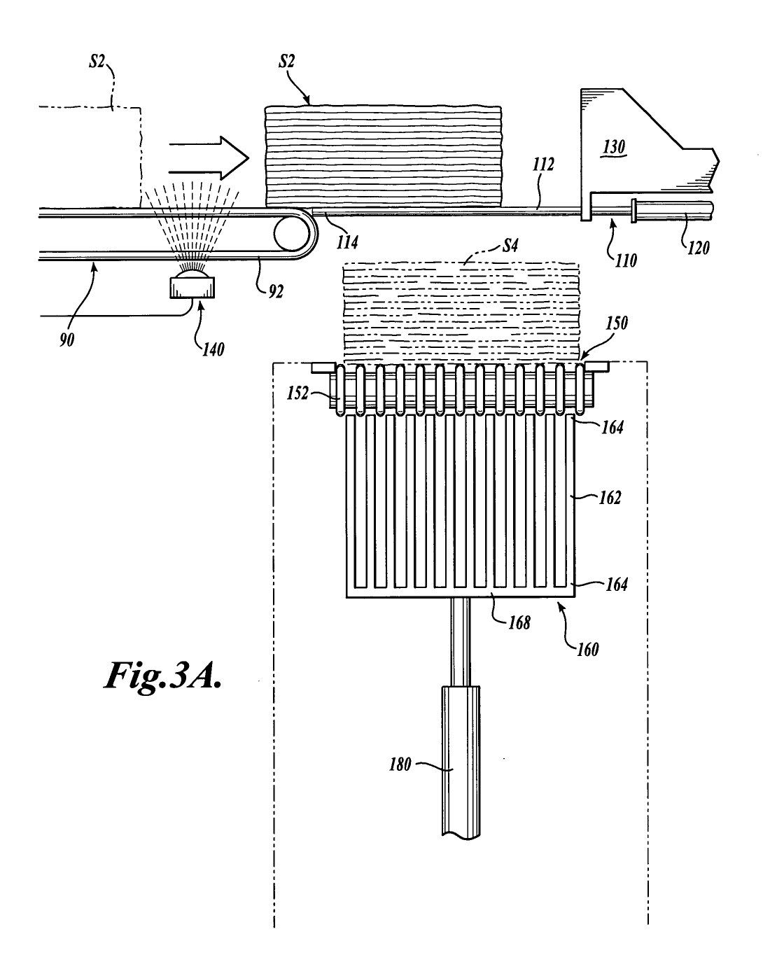

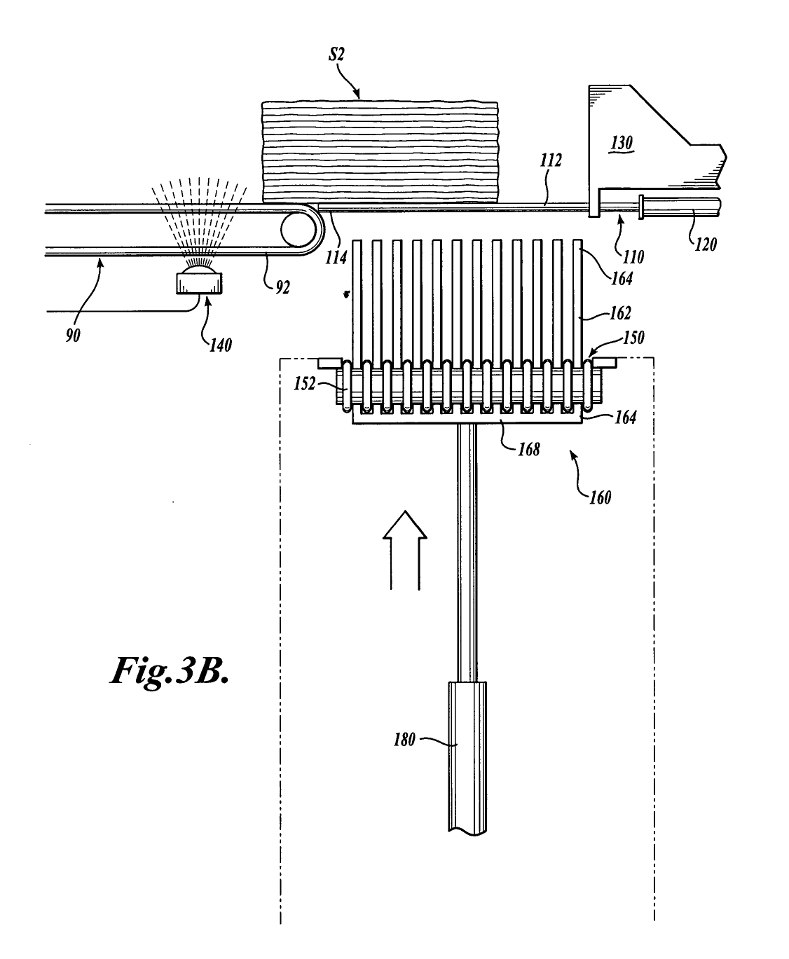

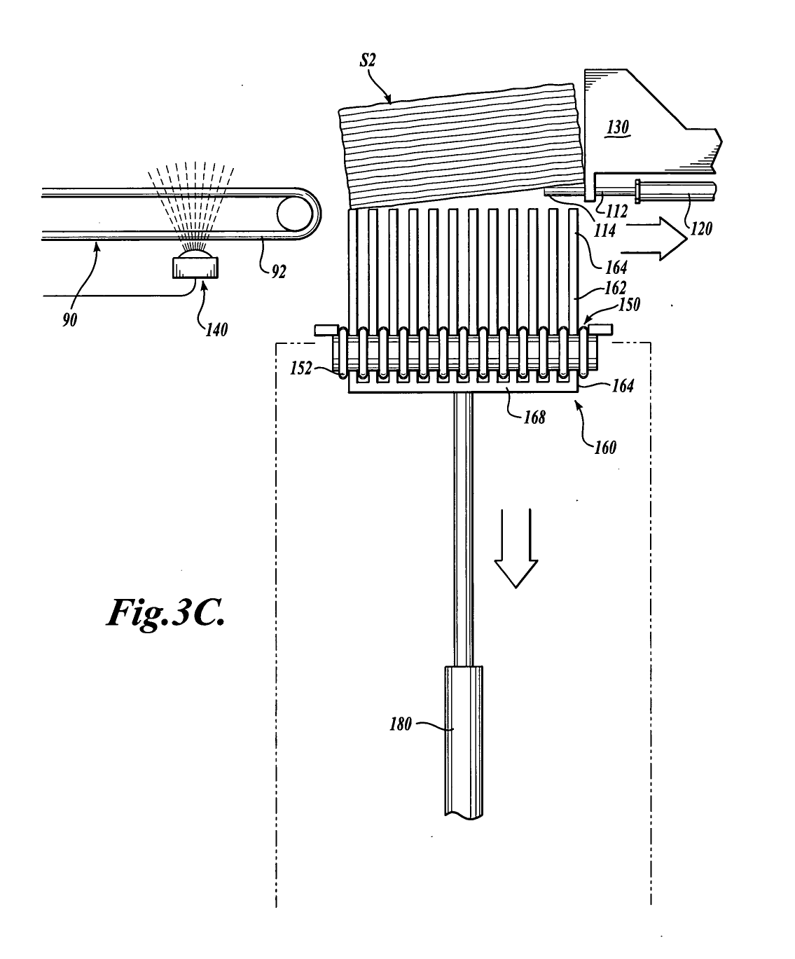

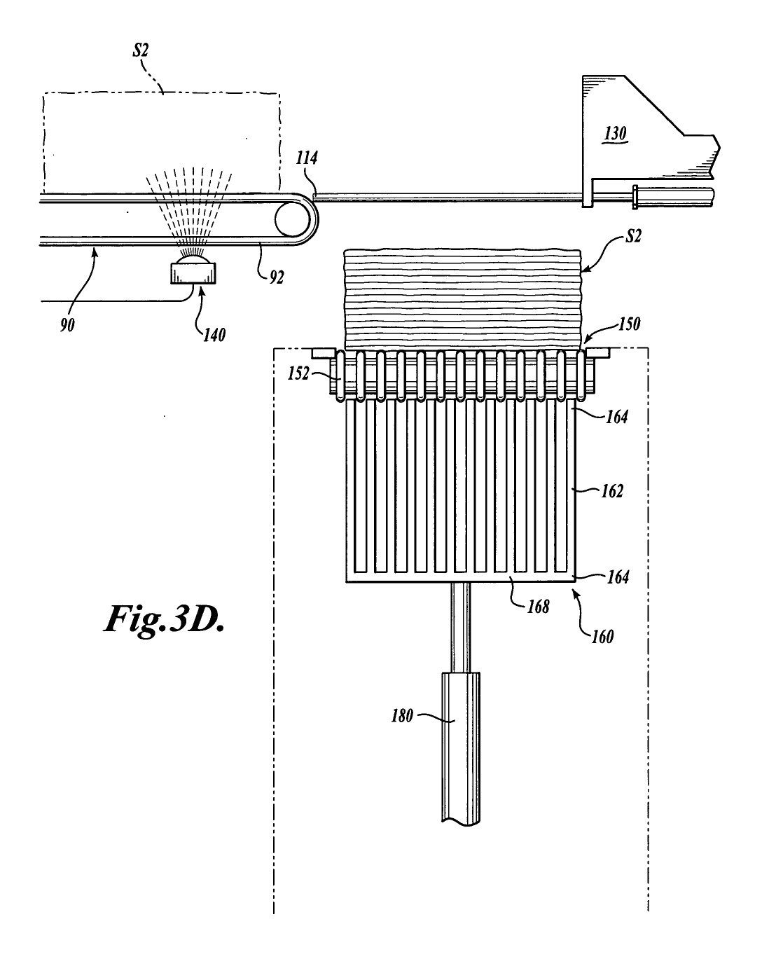

Referring now to FIGS. 3A-3D, the operation of the transfer apparatus 100 will be described in more detail. FIG. 3A shows a stack S2 of food product having just moved into position for transferring from the upper, multi-row conveyor 90 to the lower, single-row conveyor 150. The fork member 110 is in the extended position, with the free distal end 114 of the fingers 112 disposed near or adjacent the multi-row conveyor 90, whereby the multi-row conveyor 90 moves the stack S2 substantially onto the fork member 110. A detector—for example, an optical detector 140 (shown schematically in FIG. 3A)—is positioned in each row of stacks near or on the multi-row conveyor 90. The detector 140 is operable to detect the stack S2 as it moves into position on a fork member 110, and generates a signal to a controller (not shown), indicating that the stack S2 is in position for transfer to the single-row conveyor 150. The elevator 160 is in the retracted position, such that it does not impede the progress of any stack such as stack S4 (shown in phantom) on the single-row conveyor 150.

Upon receipt of a control signal indicating the stack S2 is ready to be transferred and that no other stack (such as stack S4) will be impeded by the extended elevator 160, the controller engages the vertical actuator 180, extending the elevator 160 to the extended position. The panels 162 extend upwardly, passing between adjacent belts 152 of the single-row conveyor 150, such that the distal ends 164 of the panels 162 are disposed near the corresponding fork member 110, as shown in FIG. 3B. The elevator 160 is now in position to receive the stack S2.

With the elevator 160 in the extended position, the controller directs the corresponding fork member 110 to retract. As the fork 110 retracts, the stack S2 initially moves with the fingers 112 toward the backstop 130. The backstop 130 stops the horizontal motion of the stack S2, however, allowing the fingers 112 to slidably disengage from the stack S2, thereby depositing the stack S2 onto the elevator 160, as indicated in FIG. 3C.

Upon retraction of the fork member 110, the elevator 160 retracts, such that the distal end 164 of the panels 162 are disposed below the top of the single-row conveyor 150, thereby placing the stack S2 relatively gently on the conveyor 150, as shown in FIG. 3D. The fork 110 returns to the extended position, upon retraction of the corresponding elevator 160.

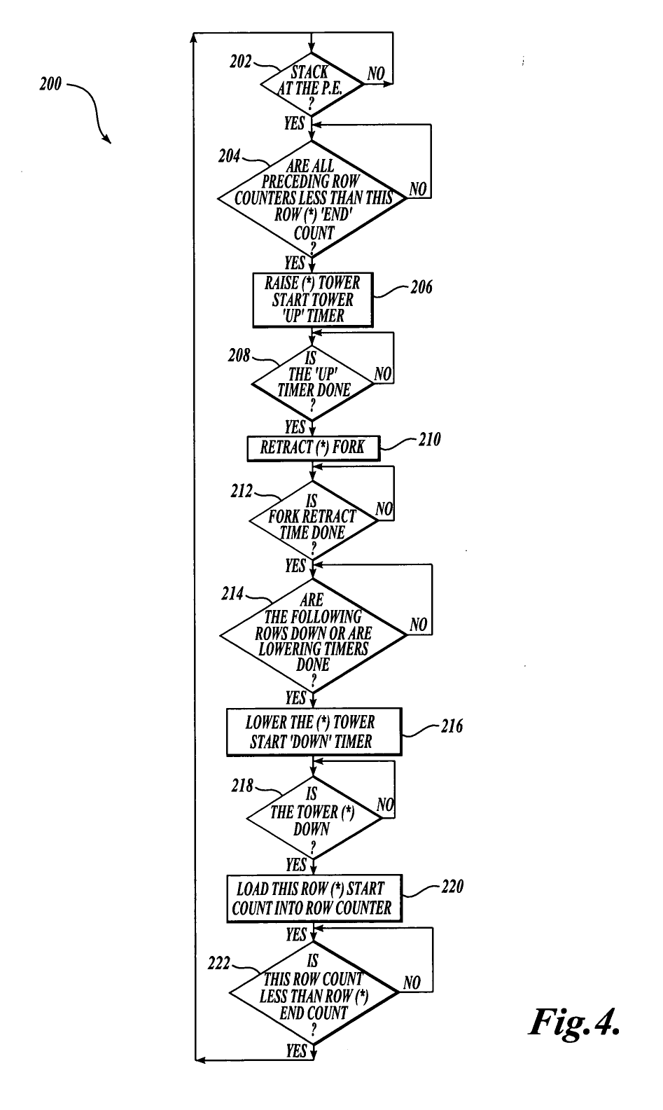

The operation of the disclosed embodiment of the present invention will now be described in more detail, with reference to the flow chart of FIG. 4, which shows the method 200 for each row, i.e., each fork 110 and corresponding elevator 160 combination. Each row follows essentially the same method, and with reference to FIG. 4, the subject row, fork, and elevator will be referred to as the “current” row, fork, and elevator, with rows disposed upstream of the current row (with respect to the single-row conveyor 150) referred to as preceding rows, and the downstream rows referred to as following rows.

The detector 140—which in this embodiment, is a photoelectric eye (P.E.), but may alternatively be any other suitable detector, including, for example, a mechanical switch, motion detector, thermal detector, or the like—monitors for the arrival of a stack of product 202. When a stack is detected as being in position for transfer, the controller checks to see if all preceding row counters are less then the current row end count 202. As indicated at step 220, when an elevator completes its cycle and is retracted, it resets a start counter for that row. For each row, an “end count” for each preceding row is known, the “end count” being the time required for a stack deposited by that preceding row to clear the current row. When a stack is in position for transfer, therefore, the controller first checks for the current row if all of the preceding row counters have reached their end count, indicating the single-row conveyor 150 is ready to receive the current stack.

If all preceding rows have reached their respective end count, then the controller commands the current elevator to rise, and sets an “up” timer 206. The up timer is used to determine when the elevator is fully extended, and is used so that the fork does not retract before the elevator is fully extended. When the up timer is done 208, indicating the elevator is fully extended, the current fork is commanded to retract 210. When the fork is fully retracted 212, such that the stack is placed on the elevator as described above, the controller checks that the elevators for the following rows are retracted sufficiently 214. When the following row elevators are retracted sufficiently, the controller signals the current elevator to retract, and sets a “down” timer 216. It will be appreciated that the following elevators do not need to be fully retracted because it will take some time for the current elevator to retract. Therefore, if the following elevators are already moving toward the retracted position, the current elevator can begin retracting.

When the current elevator is fully retracted 218, the controller resets the start time 220 for the current row, so that following elevators do not extend while the current stack is in the way, as discussed above. Finally, prior to checking the current row for a new stack 202, the controller checks that sufficient time has passed that the current stack has cleared the elevator 222.

Although the method of the presently preferred embodiment has been described, it will be appreciated that the command sequence may be implemented in different ways, without departing from the present invention. For example, rather than utilizing timers to coordinate the actions of corresponding elevators and forks, switches and/or additional detectors may be used to accomplish these steps. For example, a switch may be used to signal full extension of an elevator, and causing the corresponding fork to retract.

It will be appreciated that the present invention provides a method and apparatus for transferring multiple rows of stacked product, arriving at the transfer station at random or pseudo-random intervals, to be transferred onto a single-row conveyor. Moreover, the system of the present invention provides considerable flexibility. The transfer apparatus 100 can simply handle differing size products, for example. As mentioned above, the backstop 130 is preferably adjustable, whereby the horizontal position of the stacks may be selectively adjusted, for example to center the stacks on the single-row conveyor 150.

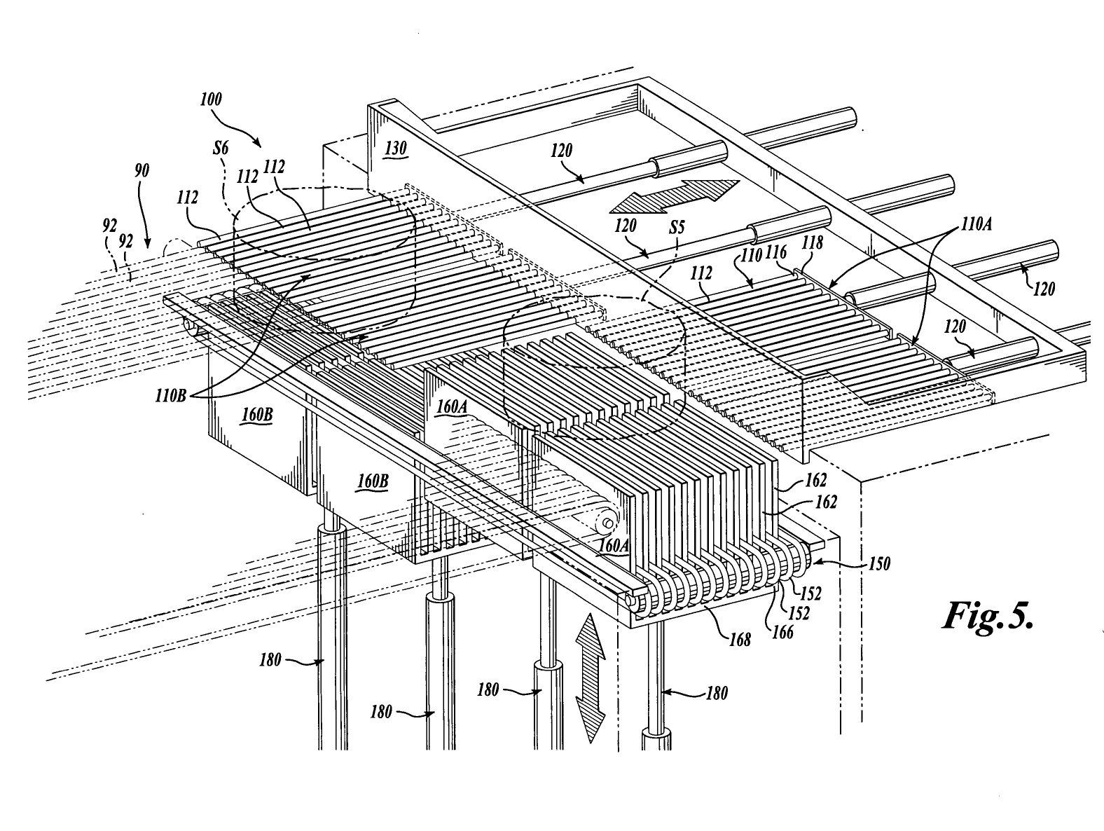

In addition, as indicated by FIG. 5, with only minor and straightforward changes to the control system, the fork 110 and elevator 160 elements may be controlled to work in groups of two—for example, to accommodate larger product. It will be appreciated that flour tortillas, for example, are made in many different sizes—from several inches in diameter to 15 inches or more. In the present invention, the forks 110 and elevators 160 may be sized to accommodate the stacks of smaller product, and to work in pairs to accommodate fewer rows of stacks of larger diameter stacks. For example, as indicated in FIG. 5, when operating the transfer apparatus 100 in a mode to accommodate larger items, the pair of fork members 110A may be operated in tandem, and the two fork members 110B may be operated in tandem. Similarly, the two elevators 160A may be operated together, and the other two elevators 160B may be operated together. FIG. 5 shows a larger-diameter stack S5 on elevators 160A ready to be lowered onto the single-row conveyor 150 by the elevators 160B operating as a unit, and a second larger-diameter stack S6 positioned on the fork members 110B, and in position to be lowered. As mentioned above, the backstop 130 may preferably be adjustably mounted such that the horizontal position of the backstop 130 may be selectively set to accommodate different stack sizes.

While the preferred embodiment of the invention has been illustrated and described, it will be appreciated that various changes can be made therein without departing from the spirit and scope of the invention.

1. A conveyor transfer apparatus for stacks of product comprising:
a first conveyor adapted to transport multiple rows of stacks of flat product, the first conveyor having a distal end;
an upright backstop disposed opposite the distal end of the first conveyor and spaced a distance from the first conveyor;
a second conveyor disposed below the distal end of the first conveyor and oriented transversely to the first conveyor, the second conveyor having a plurality of parallel, spaced-apart endless loop conveyor belts;
a plurality of fork members disposed in part behind the backstop, each fork member having a distal, end and selectively movable between an extended position, wherein the distal end is disposed adjacent the first conveyor, and a retracted position, wherein the distal end is disposed at or behind the backstop, each fork member adapted to receive a stack of flat product from the first conveyor when the fork member is in the extended position; and
a plurality of elevator members disposed in part below the second conveyor, each elevator member having a distal end and selectively movable between an up position, wherein the distal end is disposed near one of the plurality of fork members, and a down position, wherein the distal end is disposed at or below the second conveyor, each elevator member adapted to receive a stack from the fork member when the elevator member is in the up position.

2. The apparatus of claim 1, wherein each of the plurality of elevator members includes a plurality of vertical panels sized and spaced to extend between adjacent second conveyor endless-loop conveyor belts, and a transverse member interconnecting the plurality of panels.

3. The apparatus of claim 1, wherein each of the plurality of fork members includes a plurality of fingers that slidably extend through apertures in the backstop, and a transverse member interconnecting the plurality of fingers.

4. The apparatus of claim 1, wherein the plurality of fork members comprises at least four fork members, and the plurality of elevator members comprises at least four elevator members.

5. The apparatus of claim 1, wherein the backstop is horizontally adjustable.

6. The apparatus of claim 1, wherein the backstop is a vertical flat wall.

7. The apparatus of claim 1, further comprising a plurality of detectors that is adapted to detect when a stack is in a predetermined position.

8. The apparatus of claim 7, further comprising a controller that receives input signals from the plurality of detectors and sends control signals for selectively moving the plurality of fork members and the plurality of elevator members.

9. The apparatus of claim 7, wherein each of the plurality of fork members further comprises an actuator that is operative to selectively move the fork member between the extended position and the retracted position.

10. The apparatus of claim 8, wherein the plurality of fork members is adapted to be operable independently for smaller-diameter stacks and to be operable in tandem for larger-diameter stacks.

11. A method for transferring stacks of flat product from a first conveyor having multiple rows of stacks to a second conveyor, the method comprising the steps of:
positioning the second conveyor below the first conveyor, near a distal end of the first conveyor;
horizontally extending a forked member, positioned to receive a stack of flat product from the first conveyor;
vertically extending an elevator member over the second conveyor, and positioned to receive the stack of flat product from the forked member;
horizontally retracting the forked member while preventing stack of flat product from moving horizontally, such that the stack of flat product transfers to the elevator member; and
vertically retracting the elevator member such that the stack of flat product is placed gently on the second conveyor.

12. The method of claim 11, wherein a forked member and an elevator member are provided for each of the multiple rows of stack on the first conveyor.

13. The method of claim 12, wherein the extending and retracting of the fork members and of the elevator members are accomplished automatically with a controller.

14. The method of claim 13, further comprising the step of detecting when a stack of flat product is in position to be transferred and communicating the detection of the stack of flat product to the controller.

15. The method of claim 14, further comprising the step of determining when the elevator can be extended without interfering with other stacks of flat product on the second conveyor.

16. The method of claim 15, wherein the determination of when the elevator can be extended depends in part on the time, since other elevators have been retracted.

17. A tortilla transfer apparatus comprising:
a first conveyor adapted to transport multiple rows of stacks of tortillas from a tortilla stacker, the first conveyor having a distal end;
a backstop disposed opposite the distal end of the first conveyor, and spaced a distance from the first conveyor;
a second conveyor disposed below the distal end of the first conveyor and oriented transversely to the first conveyor, the second conveyor having a plurality of parallel, spaced-apart endless-loop conveyor belts;
a plurality of horizontally movable first platforms, each first platform having a free end, and each first platform movable between an extended position, wherein the free end is disposed near the distal end of the first conveyor, and a retracted position, wherein the free end is disposed near the backstop; and
a plurality of vertically movably second platforms having a number of parallel, spaced-apart vertical panels, each second platform having an upper end, and each second platform movable between an extended position, wherein the upper end of the second platform is disposed near one of the plurality of first platforms, and a retracted position, wherein the upper end of the second platform is disposed below the second conveyor;
wherein each of the first platforms is adapted to receive a stack of tortillas from the first conveyor when the first platform is in the extended position, and each of the second platforms is adapted to receive a stack of tortillas from one of the plurality of first platforms when the second platform is in the extended position, and to deposit the received stack of tortillas on the second conveyor when the second platform is in the retracted position.

18. The apparatus of claim 17, wherein the second platform vertical panels are sized and spaced to extend between adjacent second conveyor endless-loop conveyor belts.

19. The apparatus of claim 17, wherein each of the plurality of first platforms includes a plurality of fingers that slidably extends through apertures in the backstop, and a transverse member interconnecting the plurality of fingers.

20. The apparatus of claim 17, wherein the plurality of first platforms comprises at least four first platforms, and the plurality of second platforms comprises at least four second platforms.

21. The apparatus of claim 17, wherein the backstop is horizontally adjustable.

22. The apparatus of claim 17, wherein the backstop is a vertical flat wall.

23. The apparatus of claim 17, further comprising a plurality of detectors that is adapted to detect when a stack of tortillas is in a predetermined position.

24. The apparatus of claim 23, further comprising a controller that receives input signals from the plurality of detectors, and sends control signals for selectively moving the plurality of first and second platforms.

25. The apparatus of claim 23, wherein each of the plurality of first platforms further comprises an actuator that is operable to selectively move the second platform between the extended position and the retracted position.

26. The apparatus of claim 24, wherein the plurality of second platforms is adapted to be operable independently for smaller-diameter stacks and to be operable in tandem for larger-diameter stacks of tortillas.
